(19) United States
(12) Patent Application Publication
(10) Pub. No.: US 2014/0355730 A1
(43) Pub. Date: Dec. 4, 2014

(54) REACTOR OSCILLATION POWER RANGE MONITOR, REACTOR OSCILLATION POWER RANGE MONITORING METHOD, AND RECORDING MEDIUM CONTAINING REACTOR OSCILLATION POWER RANGE MONITORING PROGRAM

(71) Applicant: KABUSHIKI KAISHA TOSHIBA, MINATO-KU (JP)

(72) Inventors: SEIGO SATO, YOKOHAMA-SHI (JP); TADASHI MIYAZAKI, YOKOHAMA-SHI (JP); TOSHIAKI ITO, KOTO-KU (JP); NAOTAKA ODA, YOKOHAMA-SHI (JP); YASUSHI GOTO, YOKOHAMA-SHI (JP); YUTAKA TAKEUCHI, TOCHIGI-SHI (JP); KAZUKI YANO, YOKOHAMA-SHI (JP); NORIO SAKAI, YOKOHAMA-SHI (JP)

(73) Assignee: KABUSHIKI KAISHA TOSHIBA, MINATO-KU (JP)

(21) Appl. No.: 14/289,727

(22) Filed: May 29, 2014

(30) Foreign Application Priority Data
May 30, 2013 (JP) 2013-114587

(51) Int. Cl. G21C 17/00

(52) U.S. Cl. CPC G21C 17/00
USPC 376/259

(57) ABSTRACT

According to one embodiment, a reactor oscillation power range monitor includes: a receiving unit configured to receive LPRM signals issued by LPRM detectors differing in vertical position out of a plurality of LPRM detectors placed in a reactor core; a specification unit configured to specify any exclusion signal which meets an exclusion condition out of the received LPRM signals; an estimation unit configured to estimate an alternative signal for the exclusion signal based on a regular signal which does not meet the exclusion condition out of the received LPRM signals; an arithmetic averaging unit configured to output an arithmetically averaged signal obtained by arithmetically averaging the regular signal and the alternative signal; a time averaging unit configured to output a time-averaged signal obtained by time-averaging the arithmetically averaged signal; and a calculation unit configured to output a standard value obtained by dividing the arithmetically averaged signal by the time-averaged signal.

### CROSS-REFERENCE TO RELATED APPLICATIONS

This application is based upon and claims the benefit of priority from Japanese Patient application No. 2013-114587, filed on May 30, 2013, the entire contents of each of which are incorporated herein by reference.

### BACKGROUND OF THE INVENTION

1. Field of the Invention

The present invention relates to a technique for monitoring an oscillation power range of a reactor.

2. Description of the Related Art

In a boiling water reactor, power oscillations are observed through which reactor power is amplified by repeating rises and falls while voids appear and disappear in cooling water passing through a reactor core.

Since such power oscillations cause degradation of fuel soundness, an oscillation power range monitor (OPRM) extracts and monitors oscillation components of output signals from local power range monitoring (LPRM) (e.g., Japanese Patent No. 3064084).

If power oscillations in excess of a predetermined level are observed, it is determined that there is something abnormal and measures are taken to trip the reactor and decrease reactor power.

When an LPRM signal input to OPRM meets an exclusion condition, determination as to whether power oscillations are normal or abnormal is made based on other LPRM signals.

Also, the cooling water flows into the reactor core through lower part, starts boiling under heat, flows in a biphasic state of water and steam, and then gets out of the reactor core through upper part of the reactor core.

In this way, since the cooling water flows from the lower side of the reactor core to the upper side of the reactor core, LPRM signals respond to power oscillations more quickly on the lower side of the reactor core than on the upper side of the reactor core.

Therefore, the LPRM signals which respond to power oscillations of the reactor core contain phase differences which depend on vertical positions of detectors.

For this reason, when the LPRM signal on the lower side of the reactor core meets the exclusion condition, it is feared that there may be a delay in timing to output a result of the above-described determination as to whether power oscillations are normal or abnormal.

### SUMMARY OF THE INVENTION

The present invention has been made in view of the above circumstances and has an object to provide a reactor oscillation power range monitoring technique which outputs a determination result on abnormality/normalcy of power oscillations with appropriate timing even when an LPRM signal which meets an exclusion condition is produced.

### BRIEF DESCRIPTION OF THE DRAWINGS

FIG. 1 is a block diagram showing an embodiment of a reactor oscillation power range monitor according to the present invention;

FIG. 2 is a block diagram showing an embodiment of an oscillation component extraction unit applied to the reactor oscillation power range monitor;

FIG. 3 is a flowchart describing operation of the reactor oscillation power range monitor according to the embodiment;

FIG. 4 is a block diagram showing a reference example of an oscillation component extraction unit derived from the embodiment of the present invention; and

FIG. 5 is a block diagram showing another reference example of an oscillation component extraction unit derived from the embodiment of the present invention.

### DETAILED DESCRIPTION OF THE PREFERRED EMBODIMENTS

An embodiment of the present invention will be described below with reference to the accompanying drawings.

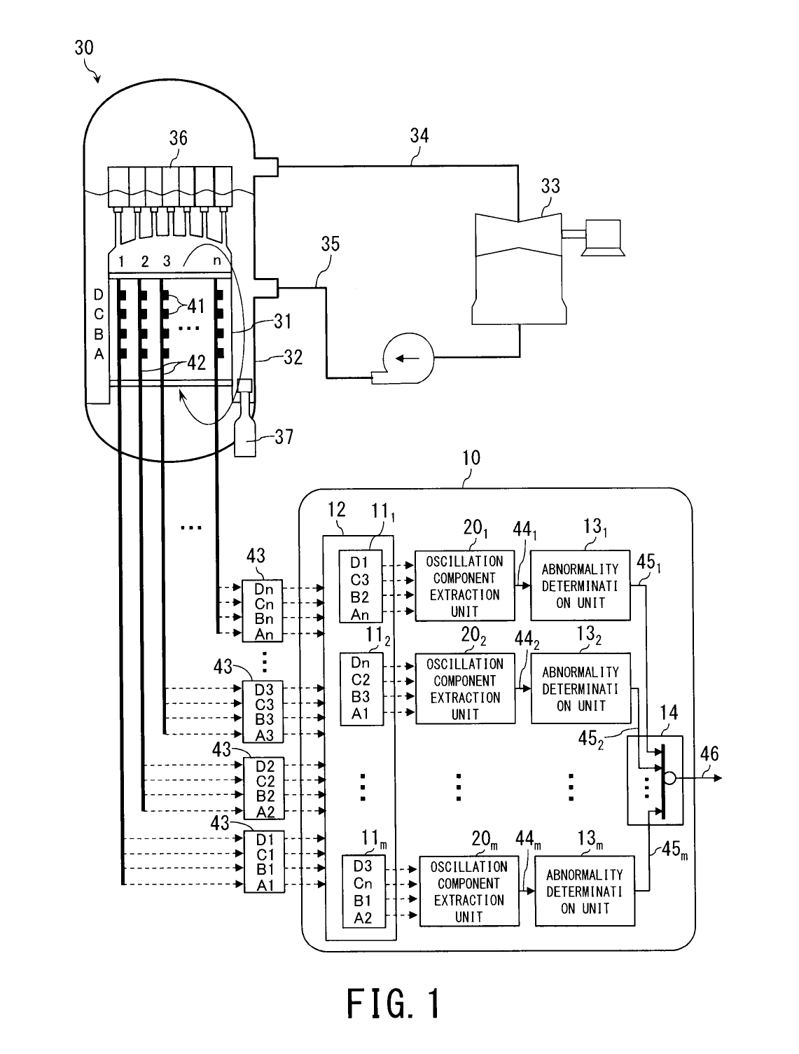

As shown in FIG. 1, a reactor 30 includes a pressure vessel 32 adapted to house a reactor core 31, a main steam line 34 adapted to lead steam generated in the reactor core 31 to a turbine 33, and a water supply pipe 35 adapted to return feed water to the pressure vessel 32 again, where the feed water is produced when the steam is cooled and condensed after working in the turbine 33.

The steam generated in the reactor core 31 is separated from water by a steam-water separator 36 and then led to the main steam line 34, as described above, for use in power generation while the water separated from the steam merges with the feed water returned from the water supply pipe 35. After the merge, the reactor water passes the reactor core 31 again by being driven by plural recirculation pumps 37 installed in a circumferential direction (only one of the pumps 37 is shown in FIG. 1, omitting the rest). Meanwhile, the reactor water is heated and turned into a two-phase flow of steam and water and then led to the steam-water separator 36 again. The process described above is repeated.

The reactor core 31 is made up of fuel assemblies (not shown) containing nuclear fuel, control rods (not shown) adapted to control nuclear fission reaction of the nuclear fuel, LPRM detectors 41 adapted to detect neutrons released as a result of the nuclear fission reaction, and instrumentation pipes 42 adapted to guide signal lines to outside the pressure vessel 32 while supporting the LPRM detectors 41, all of which are arranged in large numbers.

The LPRM detectors 41 (41_{A}, 41_{B}, 41_{C}, and 41_{D}) installed at four locations of each of the instrumentation pipes 42 (42₁, 42₂, . . . , 42ₙ) in a vertical direction are referred to as an A level, B level, C level, and D level, respectively, according to height positions from below.

The reactor water with circulates inside the reactor core 31 flows in at the A level, starts boiling by being heated by fuel, and reaches the B level, C level, and D level in sequence while changing a biphasic state of water and steam.

Then, the biphasic state (ratio between water and steam) varies due to a pressure propagation delay of the reactor water flowing from below upward in the reactor core 31 and responses of the LPRM detectors 41 (41_{A}, 41_{B}, 41_{C}, and 41_{D}) delay increasingly as positions get higher.

This will cause phase differences among power oscillations of LPRM signals 43 detected at the A level, B level, C level, and D level.

Hereinafter, outputs from the A level, B level, C level, and D level LPRM detectors 41_{A}, 41_{B}, 41_{C,}and 41_{D} on the nth instrumentation pipe 42n will be designated as LPRM signals 43Aₙ, 43Bₙ, 43Cₙ, and 43Dₙ, respectively.

An oscillation power range monitor 10 includes a signal allocation unit 12 adapted to allocate the LPRM signals 43 issued by the LPRM detectors 41 to plural cells 11 (11₁, 11₂, . . . , 11ₘ), the LPRM detectors being combined in such a way as not to coincide in vertical and horizontal positions with respect to the reactor core 31, determination units 13 (13₁, 13₂, . . . , 13ₘ) adapted to output results of determination as to abnormality/normalcy of standard values 44 (44₁, 44₂, . . . , 44ₘ) output from an oscillation component extraction units 20 (20₁, 20₂, . . . , 20ₘ) with respect to the respective cells 11 (11₁, 11₂, . . . , 11ₘ), and a command output unit 14 adapted to output a core control command 46 based on plural determination results 45 (45₁, 45₂, . . . , 45ₘ) output with respect to respective ones of the plural cells 11 (11₁, 11₂, . . . , 11ₘ).

Note that although only one partition is illustrated, an oscillation power range monitor of the boiling water reactor is made up of plural partitions.

Also, the LPRM signals 43 input to the oscillation power range monitor 10 are converted from analog signals into digital signals by an A/D converter (not shown).

The signal allocation unit 12 accepts input of the LPRM signals 43 and allocates the LPRM signals to the cells 11 (11₁, 11₂, . . . , 11ₘ) by combining the LPRM signals in such a way as not to coincide in vertical and horizontal positions with respect to the reactor core 31.

The cell 11 is a concept which systematically classifies the LPRM detectors 41 distributed over the entire reactor core 31 into a number of groups.

The LPRM signals 43A, 43B, 43C, and 43D allocated to the respective cells 11 (11₁, 11₂, . . . , 11ₘ) are combined so as to partially overlap one another among the cells 11, providing sufficient redundancy to ensure that power oscillations will be detected.

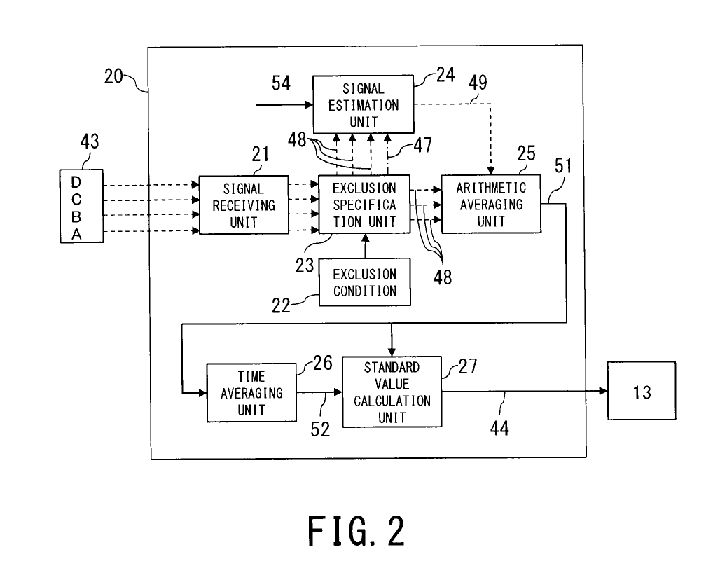

As shown in FIG. 2, each of the oscillation component extraction units 20 (20₁, 20₂, . . . , 20ₘ) includes a receiving unit 21 configured to receive the LPRM signals 43 (43A, 43B, 43C, and 43D) issued by LPRM detectors differing in vertical position out of the plural LPRM detectors placed in the reactor core; a specification unit 23 configured to specify any exclusion signal 47 which meets an exclusion condition 22 out of the received LPRM signals 43; an estimation unit 24 configured to estimate an alternative signal 49 for the exclusion signal 47 based on a regular signal 48 which does not meet the exclusion condition 22 out of the received LPRM signals 43; an arithmetic averaging unit 25 configured to output an arithmetically averaged signal 51 obtained by arithmetically averaging the regular signal 48 and the alternative signal 49; a time averaging unit 26 configured to output a time-averaged signal 52 obtained by time-averaging the arithmetically averaged signal 51; and a calculation unit 27 configured to output a standard value 44 obtained by dividing the arithmetically averaged signal 51 by the time-averaged signal 52.

The LPRM signals 43 (43A, 43B, 43C, and 43D) received by the signal receiving units 21 (21₁, 21₂, . . . , 21ₘ) contain oscillations attributable to noise components in addition to oscillations attributable to the power oscillations.

Therefore, the signal receiving unit 21 performs a filtering process as well to remove these noise components.

The exclusion specification unit 23 specifies those of the LPRM signals 43 which meet exclusion conditions 22 (1) to (3) below as exclusion signals 47 while specifying those of the LPRM signals 43 which do not the meet exclusion conditions 22 as regular signals 48.

(1) The LPRM detector of a sender is in a failed state, (2) something abnormal has occurred on a transmission path of an LPRM signal upstream of OPRM, (3) the value of a LPRM signal is smaller than a set value (e.g., less than 5%).

The signal estimation unit 24 accepts as input the exclusion signal 47 and regular signal 48 from the exclusion specification unit 23 and estimates an alternative signal 49 for the exclusion signal 47 based on the regular signal 48.

Next, some methods for estimating the alternative signal 49 will be described.

As an example of the method for estimating the alternative signal 49, a method which uses in-core flow velocity information 54 obtained by known means will be described.

The signal estimation unit 24 acquires a period T of power oscillations and a flow velocity V, where the period T of power oscillations is derived by an abnormality determination unit 13 described later and the flow velocity V is used as the flow velocity information 54.

Now, let L denote spacing between the LPRM detector 41 (FIG. 1) which outputs the exclusion signal 47 and the nearest LPRM detector 41 which outputs the regular signal 48.

Then, the alternative signal 49 for the exclusion signal 47 is considered to be oscillating with a phase difference of θ given by Eq. (1) below with respect to the nearest regular signal 48.

θ=L/(VT) (1)

Thus, for example, if the A level LPRM signal 43A is an exclusion signal 47, the B level LPRM signal 43B which is the nearest regular signal 48 is advanced by a phase of θ and designated as an alternative signal 49.

Note that the flow velocity V (flow velocity information) to be substituted into Eq. (1) can be determined from phase differences among plural regular signals 48.

That is, if t_{B} denotes a peak top time of the power oscillations of the B level LPRM signal 43B which is a regular signal 48 and t_{C} denotes a peak top time of the power oscillations of the C level LPRM signal 43C, the flow velocity V is given by Eq. (2) below.

V=L/(t_{C}−t_{B}) (2)

A constant set in advance may be used as the phase difference θ without using Eq. (1) above. That is, by setting the phase difference θ (constant) beforehand according to a height level of the sender of the exclusion signal 47, the nearest regular signal 48 may be advanced by the phase of θ (constant) and designated as an alternative signal 49.

Also, the alternative signal 49 may be estimated using amplitude values of plural regular signals 48 without using the phase difference θ.

That is, for example, if the A level LPRM signal 43A is an exclusion signal 47, the B level LPRM signal 43B which is the nearest regular signal 48 may be used as an alternative signal 49 with an amplitude of the B level LPRM signal 43B multiplied by a coefficient K (>1).

Alternatively, if a power ratio between the A level and B level is determined from longitudinal power distribution information obtained by known means, when the A level LPRM signal 43A is an exclusion signal 47, an alternative signal 49 can be estimated by multiplying the amplitude of the B level LPRM signal 43B which is the nearest regular signal 48 by a coefficient.

As another example of the method for estimating the alternative signal 49, a method which uses in-core oscillation distribution information will be described.

That is, when in-core oscillation information is known, the method uses the fact that LPRM signals 43 which are 180 degrees out-of-phase with each other are output from symmetric positions with respect to an oscillation node.

That is, for example, if the A level LPRM signal 43A is an exclusion signal 47, an alternative signal 49 can be estimated by phase-inverting (multiplying by −1) another A level LPRM signal 43A at the symmetric position with respect to an oscillation node.

The arithmetic averaging unit 25 accepts as input the regular signals 48 and alternative signals 49 from the exclusion specification unit 23 and signal estimation unit 24, respectively, arithmetically averages the signals, and thereby outputs the arithmetically averaged signal 51.

That is, the arithmetically averaged signal 51 is a signal obtained by substituting the LPRM signals 43 specified for exclusion with the alternative signals 49 and adding and averaging all the signals allocated to a given cell 11.

The time averaging unit 26 time-averages the arithmetically averaged signals 51 and thereby outputs the time-averaged signal 52. The time-averaged signal 52 is obtained by passing the arithmetically averaged signals 51 through a filter with a relatively long time constant. Alternatively, going back a predetermined period to the past from the present, an average value of plural arithmetically averaged signals 51 received in the past may be used as the time-averaged signal 52.

The time-averaged signal 52 thus obtained is a signal in which an oscillation component stemming from the power oscillations contained in the arithmetically averaged signals 51 has been removed (smoothed).

The method for calculating the time-averaged signal 52 described here is exemplary and is not intended to be limiting.

The calculation unit 27 outputs a standard value 44 obtained by dividing the arithmetically averaged signal 51 by the time-averaged signal 52. The standard value 44 is a signal that reflects the oscillation component contained in the arithmetically averaged signal 51 and has a central value of oscillations standardized to 1.

As shown in FIG. 1, the abnormality determination units 13 (13₁, 13₂, . . . , 13ₘ) output determination results 45 (45₁, 45₂, . . . , 45ₘ) on abnormality/normalcy of the standard values 44 (44₁, 44₂, . . . , 44ₘ) output from the oscillation component extraction units 20 (20₁, 20₂, . . . , 20ₘ) with respect to the respective cells 11 (11₁, 11₂, . . . , 11ₘ).

That is, the abnormality determination unit 13 outputs a determination result 45 of “abnormal” if it is determined, based on an amplitude value, amplitude amplification factor, and period derived from an oscillation waveform of the standard value 44, that there is a high risk that fuel soundness will be impaired, and output a determination result 45 of “normal” if it is determined there is a low risk.

The command output unit 14 outputs the core control command 46 based on plural determination results 45 (45₁, 45₂, . . . , 45ₘ) output from the respective ones of plural cells 11 (11₁, 11₂, . . . , 11ₘ).

The command output unit 14, which is made up of an OR logic circuit, outputs a command 46 to trip the reactor 30, when a determination result 45 of “abnormal” is produced in any one of the cells 11.

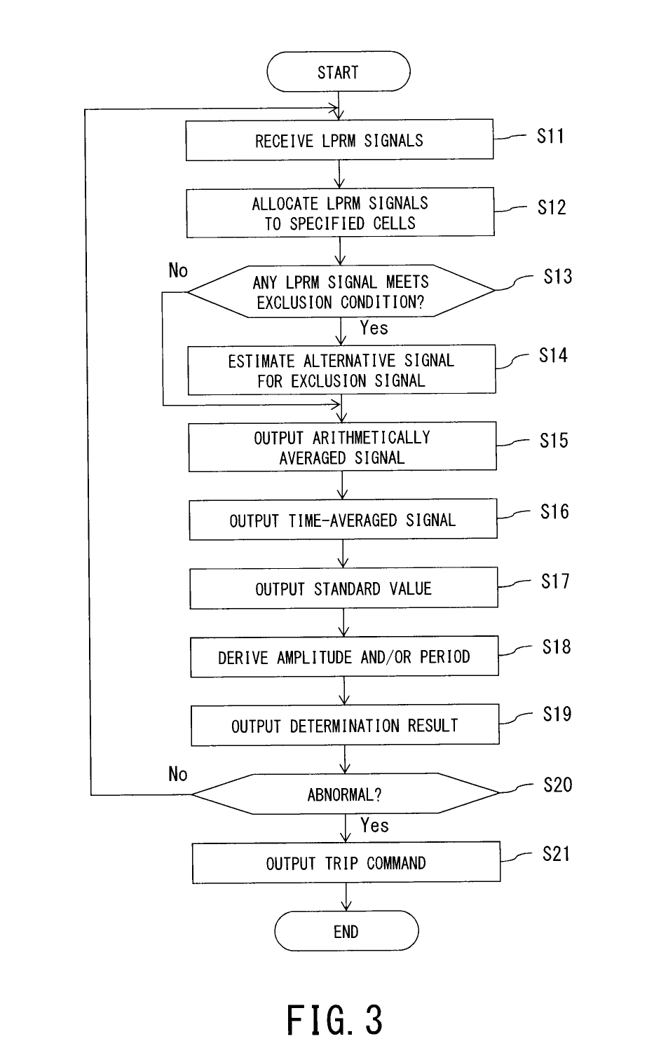

Operation of the reactor oscillation power range monitor will be described based on a flowchart of FIG. 3.

First, the LPRM signals 43 issued by the plural LPRM detectors 41 placed in the reactor core 31 are received (S11). Then, the received LPRM signals 43 are allocated to the specified cells 11 (11₁, 11₂, . . . , 11ₘ) by being combined in such a way as not to coincide in vertical and horizontal positions with respect to the reactor core (S12).

Next, the LPRM signals 43 (43A, 43B, 43C, and 43D) allocated to the cells 11 (11₁, 11₂, . . . , 11ₘ) are searched for any LPRM signal 43 which meets an exclusion condition (S13). Then, if there is any LPRM signal 43 (exclusion signal 47) which meets the exclusion condition (Yes in S13), alternative signal 49 for the exclusion signal 47 is estimated based on the regular signal 48 (S14) and then an arithmetically averaged signal 51 obtained by arithmetically averaging the regular signal 48 and alternative signal 49 is output (S15).

On the other hand, if there is no LPRM signal 43 which meets the exclusion condition (No in S13), an arithmetically averaged signal 51 obtained by arithmetically averaging all the LPRM signals 43 (regular signals 48) allocated to the cells 11 is output (S15).

Next, a time-averaged signal 52 obtained by time-averaging the arithmetically averaged signals 51 is output (S16) and a standard value 44 obtained by dividing the arithmetically averaged signal 51 by the time-averaged signal 52 is output (S17).

Then, the amplitude and/or period of the power oscillations are/is derived from the standard value 44 (S18) and a determination result 45 is output (S19).

Then, if a determination of abnormal is not contained in the determination results 45 output with respect to the respective cells 11 (11₁, 11₂, . . . , 11ₘ) (No in S20), a flow of S11 to S19 is repeated.

If even a single determination of abnormal is contained (Yes in S20), a core control command 46 (trip command) is output (S21: END).

Consequently, even if an LPRM signal 43A from lower part of the reactor core with high responsiveness meets an exclusion condition, a delay in issuance of a trip command can be lessened at the occurrence of abnormality.

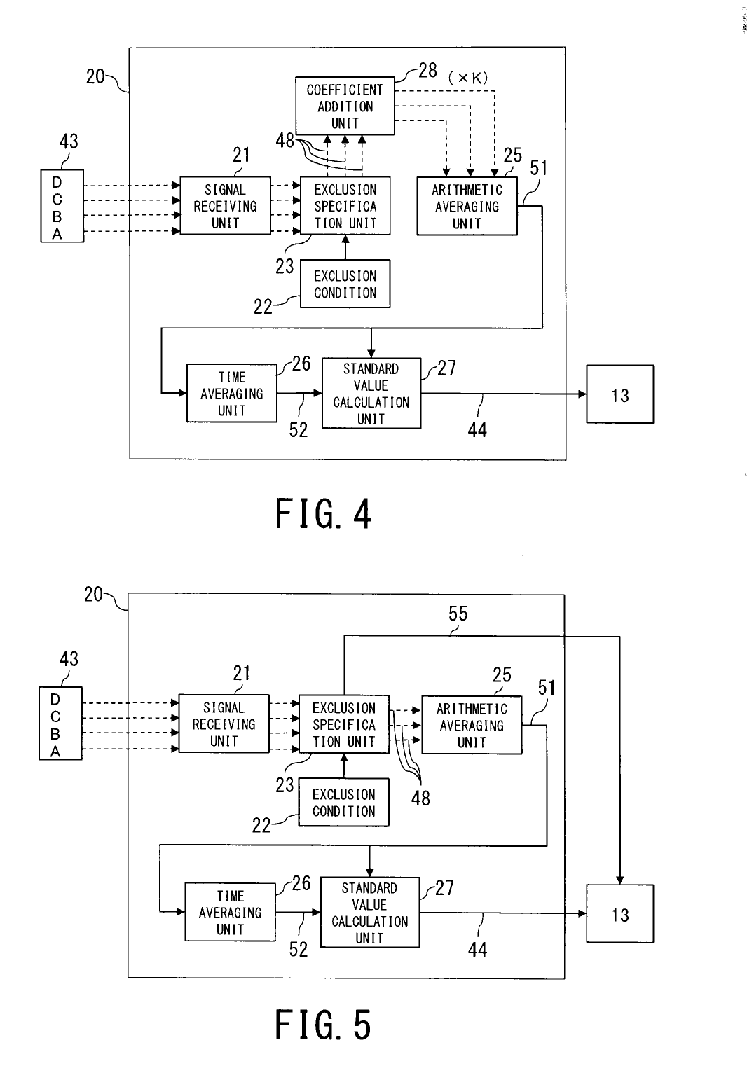

FIG. 4 shows a reference example of the oscillation component extraction unit derived from the embodiment of the present invention. In FIG. 4, common components or functions with FIG. 2 are denoted by the same reference numerals as the corresponding components or functions is FIG. 2, and redundant description thereof will be omitted.

In the reference example shown in FIG. 4, a coefficient addition unit 28 is installed instead of the signal estimation unit 24 (FIG. 2).

The coefficient addition unit 28 accepts as input any regular signal 48 which does not meet the exclusion condition 22 out of the LPRM signals 43, and outputs regular signal 48 to the arithmetic averaging unit 25 with the amplitude of the regular signal 48 multiplied by a coefficient K (>1).

Consequently, the abnormality determination unit 13 accepts input of the standard value 44 amplified by depending on the coefficient K. Note that different values of the coefficient K may be used depending on the height level of the regular signal 48 or exclusion signal.

That is, in the present reference example, since no alternative signal is estimated when part of the LPRM signals 43 meets the exclusion condition 22, abnormality/normalcy of power oscillations is determined based solely on reduced regular signals 48.

Thus, by overestimating power oscillations, timing for the abnormality determination unit 13 to switch from normal to abnormal is advanced to make the determination more conservative.

FIG. 5 shows a reference example of the oscillation component extraction unit derived from the embodiment of the present invention. In FIG. 5, common components or functions with FIG. 2 are denoted by the same reference numerals, and redundant description thereof will be omitted.

In the reference example shown in FIG. 5, the signal estimation unit 24 (FIG. 2) is not provided, and when exclusion is specified, an exclusion report 55 is sent by the exclusion specification unit 23 to the abnormality determination unit 13.

When part of the LPRM signals 43 meets the exclusion condition 22, no alternative signal is estimated and abnormality/normalcy of power oscillations is determined based solely on reduced regular signals 48.

Upon receiving the exclusion report 55, the abnormality determination unit 13 applies stricter determination criteria to the amplitude value, amplitude amplification factor, and period derived from the oscillation waveform of the standard value 44.

This advances the timing for the abnormality determination unit 13 to switch from normal to abnormal and makes the determination more conservative.

By replacing the LPRM signal which meets the exclusion condition with an alternative signal estimated based on a regular signal, the reactor oscillation power range monitor according to at least one of the embodiments described above can output a determination result on abnormality/normalcy of power oscillations with appropriate timing.

Whereas a few embodiments of the present invention have been described, these embodiments are presented only by way of example, and not intended to limit the scope of the invention. These embodiments can be implemented in various other forms, and various omissions, replacements, changes, and combinations can be made without departing from the spirit of the invention. Such embodiments and modifications thereof are included in the spirit and scope of the invention as well as in the invention set forth in the appended claims and the scope of equivalents thereof.

Also, components of the reactor oscillation power range monitor can be implemented by a processor of a computer and operated by a reactor power oscillation monitoring program.

What is claimed is:

1. A reactor oscillation power range monitor comprising:
a receiving unit configured to receive LPRM signals issued by LPRM detectors differing in vertical position out of a plurality of LPRM detectors placed in a reactor core;
a specification unit configured to specify any exclusion signal which meets an exclusion condition out of the received LPRM signals;
an estimation unit configured to estimate an alternative signal for the exclusion signal based on a regular signal which does not meet the exclusion condition out of the received LPRM signals;
an arithmetic averaging unit configured to output an arithmetically averaged signal obtained by arithmetically averaging the regular signal and the alternative signal;
a time averaging unit configured to output a time-averaged signal obtained by time-averaging the arithmetically averaged signal; and
a calculation unit configured to output a standard value obtained by dividing the arithmetically averaged signal by the time-averaged signal.

2. The reactor oscillation power range monitor according to claim 1, further comprising:
a signal allocation unit configured to allocate the LPRM signals issued by the LPRM detectors to cells, the LPRM detectors being combined in such a way as not to coincide in vertical and horizontal positions with respect to the reactor core;
a determination unit configured to output a result of determination as to abnormality/normalcy of the standard value output on a cell by cell basis; and
a command output unit configured to output a core control command based on a plurality of the determination results output with respect to respective ones of the plurality of cells.

3. The reactor oscillation power range monitor according to claim 1, wherein the estimation unit estimates the alternative signal based further on flow velocity information obtained in the reactor core.

4. The reactor oscillation power range monitor according to claim 1, wherein the estimation unit estimates the alternative signal based on phase differences among a plurality of the regular signals or on amplitude values of the plurality of regular signals.

5. The reactor oscillation power range monitor according to claim 1, wherein the estimation unit estimates the alternative signal based further on oscillation distribution information on the reactor core.

6. A reactor oscillation power range monitoring method comprising the steps of:
receiving LPRM signals issued by LPRM detectors differing in vertical position out of a plurality of LPRM detectors placed in a reactor core;
specifying any exclusion signal which meets an exclusion condition out of the received LPRM signals;
estimating an alternative signal for the exclusion signal based on a regular signal which does not meet the exclusion condition out of the received LPRM signals;
outputting an arithmetically averaged signal obtained by arithmetically averaging the regular signal and the alternative signal;
outputting a time-averaged signal obtained by time-averaging the arithmetically averaged signal; and
outputting a standard value obtained by dividing the arithmetically averaged signal by the time-averaged signal.

7. A recording medium containing a reactor oscillation power range monitoring program configured to make a computer execute the steps of:
receiving LPRM signals issued by LPRM detectors differing in vertical position out of a plurality of LPRM detectors placed in a reactor core;
specifying any exclusion signal which meets an exclusion condition out of the received LPRM signals;
estimating an alternative signal for the exclusion signal based on a regular signal which does not meet the exclusion condition out of the received LPRM signals;
outputting an arithmetically averaged signal obtained by arithmetically averaging the regular signal and the alternative signal;
outputting a time-averaged signal obtained by time-averaging the arithmetically averaged signal; and
outputting a standard value obtained by dividing the arithmetically averaged signal by the time-averaged signal.
